(19) United States
(12) Patent Application Publication
(10) Pub. No.: US 2020/0106924 A1
(43) Pub. Date: Apr. 2, 2020

(54) INFORMATION PROCESSING DEVICE, RECORDING MEDIUM STORING USER MANAGEMENT PROGRAM FOR INFORMATION PROCESSING DEVICE, AND USER MANAGEMENT METHOD

(71) Applicant: SHARP KABUSHIKI KAISHA, Sakai City (JP)

(72) Inventor: MASAHIRO MORISHITA, Sakai City (JP)

(21) Appl. No.: 16/586,684

(22) Filed: Sep. 27, 2019

(30) Foreign Application Priority Data
Sep. 28, 2018 (JP) 2018-185507

(51) Int. Cl. H04N 1/44; H04N 1/00

(52) U.S. Cl. CPC H04N 1/4433; H04N 1/0048; H04N 1/00424

(57) ABSTRACT

The multifunction peripheral according to the present invention has a quick login mode for realizing simple authentication. In the quick login mode, user information can be arbitrarily registered and edited. User information registered by a general user who does not have administrator privileges may be edited by any user, including the general user. On the other hand, user information registered by an administrator who has administrator privileges may be edited on the condition that a user who edits the user information is the administrator, and may not be edited by other general users. As a result, unintended editing of user information by a third party is prevented, and appropriate management of the user information is realized.

### BACKGROUND OF THE INVENTION

### Field of the Invention

The present invention relates to an information processing device, a user management program for an information processing device, and a user management method. In particular, the present invention relates to an information processing device provided with a display unit that displays an icon corresponding to each user based on pre-registered user information, a user management program for an information processing device, and a user management method.

### Description of the Background Art

An example of a technique of this type is disclosed in Japanese Unexamined Patent Application Publication No. 2015-227048. According to the technique disclosed in Japanese Unexamined Patent Application Publication No. 2015-227048, based on pre-registered user information, an icon corresponding to each user is displayed on a display provided as a display unit in an image forming device serving as an information processing device, such as a multifunction peripheral (MFP). When an arbitrary icon is operated, authentication is performed for the user corresponding to the icon, and then the multifunction peripheral can be used. That is to say, a user is able to log in by simply operating an icon corresponding to the user. Such simple authentication (also referred to as “quick authentication”) is very useful for reducing the time and effort associated with user operation. The user information can be arbitrarily registered by operating the multifunction peripheral body, or by operating a personal computer (hereinafter referred to as “PC”) connected to the multifunction peripheral. Furthermore, the user information can also be arbitrarily edited, or even deleted.

As described above, simple authentication is very useful for reducing the time and effort associated with user operation. On the other hand, because the user information can be arbitrarily edited, it is necessary to appropriately manage the user information so as to prevent unintended editing, particularly editing by a third party.

Therefore, the present invention has an object of providing a novel information processing device, a novel user management program for the information processing device, and a novel user management method that are capable of appropriately managing user information while preserving user convenience by means of simple authentication.

### SUMMARY OF THE INVENTION

In order to achieve the object, the present invention includes a first invention relating to an information processing device, a second invention relating to a user management program for the information processing device, and third invention relating to a user management method for the information processing device.

Among these, in the first invention which relates to an information processing device, it is assumed that the information processing device includes a display unit that displays an icon corresponding to each user based on pre-registered user information. Under this assumption, the first invention further includes an edit instruction acceptor and a permitter. The edit instruction acceptor accepts an edit instruction to edit the user information corresponding to the icon corresponding to an arbitrary user. Then, if the user information relating to the edit instruction is non-specific registered information that has been registered by a non-privileged user who does not have a specific privilege, the permitter allows editing of the user information according to the edit instruction. On the other hand, if the user information relating to the edit instruction is specific registered information that has been registered by a privileged user having the specific privilege, the permitter allows editing of the user information according to the edit instruction on the condition that a user who has transmitted the edit instruction is the privileged user.

The editing of user information referred to here includes changing the content of the user information, and deleting the user information.

In the first invention, a warning outputter may be further provided. The warning outputter outputs a predetermined warning if the user information relating to the edit instruction is the specific registered information, and a user who has transmitted the edit instruction is the non-privileged user.

Furthermore, in the first invention, a communicator may be further provided. The communicator communicates with an external device. In this case, the edit instruction acceptor may be configured to be capable of accepting an edit instruction from an external device via the communicator.

Further, in the first invention, the display unit may be configured to display one or more icons based on the specific registered information and one or more icons based on the non-specific registered information differently from each other.

In addition, the display unit may be configured to be switchable to any of a first state, a second state, or a third state. Here, the first state is a state in which only one or more icons based on the specific registered information are displayed. The second state is a state in which only one or more icons based on the non-specific registered information are displayed. Further, the third state is a state in which both of the icons based on the specific registered information and the icons based on the non-specific registered information are displayed.

Furthermore, in the first invention, a change instruction acceptor and a changer may be further provided. Among these, the change instruction acceptor accepts, from the privileged user, a change instruction to change arrangement of the icon. Then, the changer changes the arrangement of the icon according to the change instruction.

The information processing device according to the first invention is, for example, a multifunction peripheral.

In the present invention, a user management program for an information processing device according to the second invention assumes that the information processing device includes a display unit that displays an icon corresponding to each user based on pre-registered user information. Under this assumption, the second invention causes a computer of the information processing device to execute an edit instruction accepting procedure and a permission procedure. The edit instruction accepting procedure accepts an edit instruction to edit the user information corresponding to the icon corresponding to an arbitrary user. Then, if the user information relating to the edit instruction is non-specific registered information that has been registered by a non-privileged user who does not have a specific privilege, the permission procedure allows editing of the user information according to the edit instruction. On the other hand, if the user information relating to the edit instruction is specific registered information that has been registered by a privileged user having the specific privilege, the permission procedure allows editing of the user information according to the edit instruction on the condition that a user who has transmitted the edit instruction is the privileged user.

In the present invention, a user management method for an information processing device according to the third invention assumes that the information processing device includes a display unit that displays an icon corresponding to each user based on pre-registered user information. Under this assumption, the third invention includes an edit instruction accepting step and a permission step. The edit instruction accepting step accepts an edit instruction to edit the user information corresponding to the icon corresponding to an arbitrary user. Then, if the user information relating to the edit instruction is non-specific registered information that has been registered by a non-privileged user who does not have a specific privilege, the permission step allows editing of the user information according to the edit instruction. On the other hand, if the user information relating to the edit instruction is specific registered information that has been registered by a privileged user having the specific privilege, the permission step allows editing of the user information according to the edit instruction on the condition that a user who has transmitted the edit instruction is the privileged user.

According to the present invention described above, it is possible to appropriately manage user information while preserving user convenience by means of simple authentication.

### BRIEF DESCRIPTION OF THE DRAWINGS

FIG. 1 is a block diagram showing an electrical configuration of a multifunction peripheral according to a first embodiment of the present invention;

FIG. 2 is a diagram showing a state in which the multifunction peripheral according to the first embodiment is connected to a PC serving as an external device;

FIG. 3 is a diagram showing an example of a quick login screen in the first embodiment;

FIG. 4 is a diagram showing an example of a quick login screen in the first embodiment when a user is unregistered;

FIG. 5 is a diagram showing another example of a quick login screen in the first embodiment when a user is unregistered;

FIG. 6 is a diagram showing an example of an add/edit user screen in the first embodiment;

FIG. 7 is a diagram showing an example of an add/edit user screen including a user registration screen for new registrations in the first embodiment;

FIG. 8 is a diagram showing another example of an add/edit user screen in the first embodiment;

FIG. 9 is a diagram showing yet another example of an add/edit user screen in the first embodiment;

FIG. 10 is a diagram showing an example of a user registration screen for new registrations displayed on the display of a PC in the first embodiment;

FIG. 11 is a diagram conceptually showing a user management table in the first embodiment;

FIG. 12 is a diagram showing an example of an add/edit user screen including a user registration screen for editing in the first embodiment;

FIG. 13 is a diagram showing an example of an add/edit user screen in a state where a warning message is displayed in the first embodiment;

FIG. 14 is a memory map conceptually showing the configuration inside a RAM of a primary storage unit in the first embodiment;

FIG. 15 is a flow diagram showing the flow of a user management task executed by a CPU in the first embodiment;

FIG. 16 is a diagram showing an example of an add/edit user screen in a second embodiment of the present invention;

FIGS. 17A to 17C are diagrams each showing a display example of an add/edit user screen in a third embodiment of the present invention; and

FIGS. 18A and 18B are diagrams each illustrating a sequence that changes an icon arrangement of an add/edit user screen in a fourth embodiment of the present invention.

### DESCRIPTION OF THE PREFERRED EMBODIMENTS

### First Embodiment

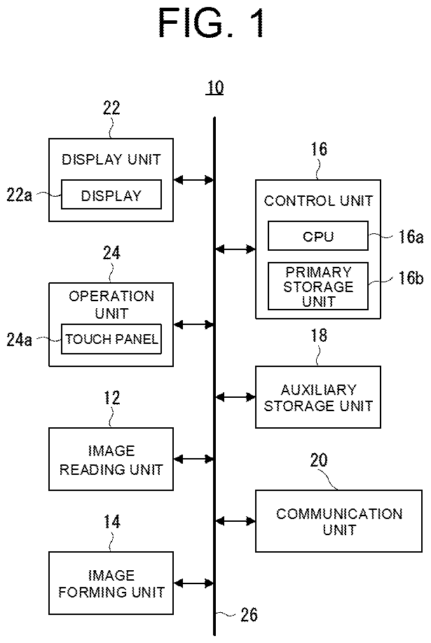

A first embodiment of the present invention will be described using the multifunction peripheral 10 shown in FIG. 1 as an example.

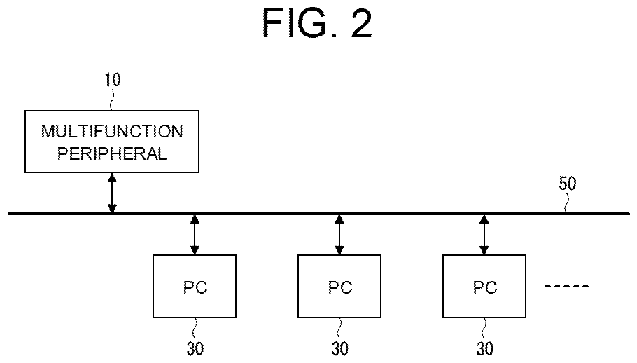

The multifunction peripheral 10 according to the first embodiment includes a plurality of functions such as a copy function, a printer function, an image scanner function, and a facsimile function. Such multifunction peripherals 10 are, for example, installed in offices. In this case, workers in the office represent the users that use the multifunction peripheral 10. At the same time, the users of the multifunction peripheral 10 include an administrator with privileges for managing the multifunction peripheral 10. Further, in the office, the multifunction peripheral 10 and one or more PCs 30 serving as external devices may be connected to each other via a network 50 as shown in FIG. 2. The network 50 referred to here is, for example, a Local Area Network (LAN). However, it is not limited to this. Although not illustrated, the network 50 may have various external devices such as routers and servers that are connected in addition to the PCs 30. Furthermore, the multifunction peripheral 10 may be connected to a public telephone line.

Referring again to FIG. 1, the multifunction peripheral 10 includes an image reading unit 12, an image forming unit 14, a control unit 16, an auxiliary storage unit 18, a communication unit 20, a display unit 22, and an operation unit 24. These are connected to each other via a common bus 26.

The image reading unit 12 is an example of an image reader that reads an image from a document (not shown), and is responsible for performing image reading processing which outputs two-dimensional image data that corresponds to the image of the document. Consequently, the image reading unit 12 includes a document placement table (not shown) on which the document is placed. At the same time, the image reading unit 12 is provided with an image reading unit (not shown) including a light source, a plurality of mirrors, an imaging lens, a line sensor, and the like, and a drive mechanism (not shown) that moves the image reading unit. Further, the image reading unit 12 may be provided with an automatic document feeder (ADF) (not shown). The image reading unit 12 is provided particularly for realizing a copy function, an image scanner function, and a facsimile function (facsimile transmission function).

The image forming unit 14 is an example of an image former, and is responsible for performing image forming processing that forms an image by the electrophotographic method on a sheet-form image recording medium such as a paper sheet (not shown). Consequently, the image forming unit 14 includes a photosensitive drum, a charging device, an exposure device, a development device, a transfer device, a fixing device and the like (not shown). After an image is formed as a result of image forming processing by the image forming unit 14, the paper sheet, that is to say, the printed article, is discharged to a paper discharge tray (not shown). In addition to black-and-white image forming processing, the image forming unit 14 is also capable of performing color image forming processing. Furthermore, the image forming unit 14 is not limited to the electrophotographic method, and may perform image forming processing by the inkjet method and the like. The image forming unit 14 is provided particularly for realizing a copy function, a printer function, and a facsimile function (facsimile reception function).

The control unit 16 is an example of a controller that governs the overall control of the multifunction peripheral 10. Consequently, the control unit 16 includes a central processing unit (CPU) 16a as a control executer. At the same time, the control unit 16 includes a primary storage unit 16b as a primary storage which is directly accessible by the CPU 16a. The primary storage unit 16b includes a read only memory (ROM) and a random access memory (RAM) (not shown). Among these, the ROM stores a control program (firmware) for controlling the operation of the CPU 16a. Further, the RAM constitutes a working area and a buffer area when the CPU 16a executes processing based on the control program.

The auxiliary storage unit 18 is an example of an auxiliary storage, and includes a non-volatile memory such as a hard disk or flash memory (not shown). The auxiliary storage unit 18 may be designated as a storage destination of the image data output from the image reading unit 12 described above, or various data received via the communication unit 20 described below.

The communication unit 20 is an example of a communicator which, by being connected to the network 50 described above, is responsible for bidirectional communication processing via the network 50. The connection between the communication unit 20 and the network 50 may be wired or wireless. Furthermore, the communication unit 20 is connected to a public telephone line as described above, and is also responsible for bidirectional communication processing via the public telephone line. The communication unit 20 is provided particularly for realizing a printer function and a facsimile function. Moreover, a variety of data may be transmitted and received between the multifunction peripheral 10, which includes an image scanner function, and various external devices. The communication unit 20 is provided to realize such a data transmission and reception function.

The display unit 22 includes a display 22a that serves as a display unit. The display 22a is, for example, a liquid crystal display (LCD). However, it is not limited to this, and may also be an organic electroluminescence (EL) display and the like. Furthermore, the display unit 22 includes, in addition to the display 22a, an appropriate light emitting element (not shown) such as a light emitting diode (LED).

The operation unit 24 is an example of an operation acceptor that accepts a user operation, and specifically includes a sheet-form touch panel 24a. The touch panel 24a is provided so as to overlap with the display surface of the display 22a. The touch panel 24a is, for example, a capacitance-type touch panel. However, it is not limited to this, and another type such as an electromagnetic induction-type, resistance film-type, or infrared-type touch panel may be used. Furthermore, the operation unit 24 includes, in addition to the touch panel 24a, an appropriate hardware switch such as a push button switch (not shown).

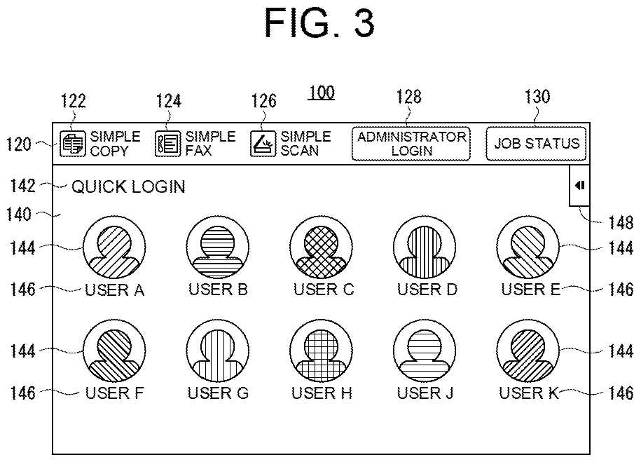

The multifunction peripheral 10 according to the first embodiment is provided with an operation mode referred to as a quick login mode for realizing simple authentication as described above. In the quick login mode, a quick login screen 100 such as that shown in FIG. 3 is displayed on the display 22a as a home screen (basic screen).

The quick login screen 100 includes a band-shaped display area 120 and a primary display area 140. Among these, the band-shaped display area 120 is a horizontal band-shaped area that occupies an upper portion of the quick login screen 100. Arranged inside the band-shaped display area 120 are, for example, a button (or more precisely, a graphic imitating a button) 122 for selecting the copy function, a button 124 for selecting the facsimile function, and a button 126 for selecting the image scanner function. At the same time, arranged inside the band-shaped display area 120 are an administrator login button 128 that enables an administrator to log in, and a job status confirmation button 130 that enables the status of a job to be confirmed.

On the other hand, the primary display area 140 represents the entire area of the quick login screen 100 excluding the band-shaped display area 120, that is to say, is a rectangular-shaped area that occupies a large section of the quick login screen 100. An appropriate character string 142 representing the title of the quick login screen 100 is arranged at an upper portion of the primary display area 140. Further, icons 144 associated with each user are arranged below the character string 142. FIG. 3 shows an example where icons 144 for ten people, that is to say, ten icons 144, are arranged in rows of five in the horizontal direction and columns of two in the vertical direction. However, the number and arrangement of the icons 144 is not limited to this. Although not illustrated, an appropriate measure is provided for displaying all of the icons 144, such as a measure for scrolling the page or switching the page, particularly when the number of icons 144 exceeds ten. Further, a character string 146 representing a login name, which is the name of the user corresponding to the icon 144, is arranged below each icon 144. In addition, a tab 148 for opening and closing an action panel 150 described below is arranged at an upper-right portion of the primary display area 140.

On the quick login screen 100, a user is capable of receiving authentication, which serves as permission to use the multifunction peripheral 10, simply by performing an operation (tap) with respect to the user's own icon 144. That is to say, the user is capable of logging in. However, icons 144 (users) with a set password as described below require input of the password. Furthermore, an administrator may log in as the administrator by pressing the administrator login button 128, and additionally inputting the required authentication information such as a specific code or password on a login screen (not shown) displayed in response to the administrator login button 128 being pressed. Unlike a user that has logged in by operating an icon 144, that is to say, a general user, an administrator that has logged in as the administrator is capable of using all of the functions provided in the multifunction peripheral 10, including detailed settings of the multifunction peripheral 10. In other words, among all of the functions provided in the multifunction peripheral 10, the functions that may be used by a general user is limited.

In addition, the quick login screen 100 that contains each of the icons 144 is displayed based on pre-registered user information. The user information is registered in the following manner.

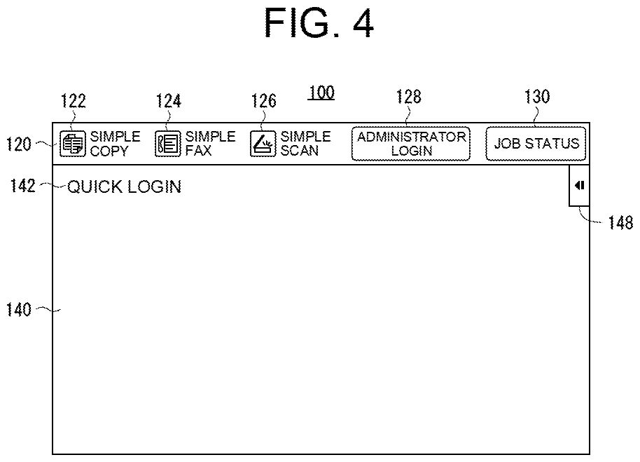

First, at the point no user information is registered, that is to say, when user information is about to be registered for the first time, a quick login screen 100 as shown in FIG. 4 is displayed. That is to say, a quick login screen 100 without icons 144 or character strings 146 is displayed.

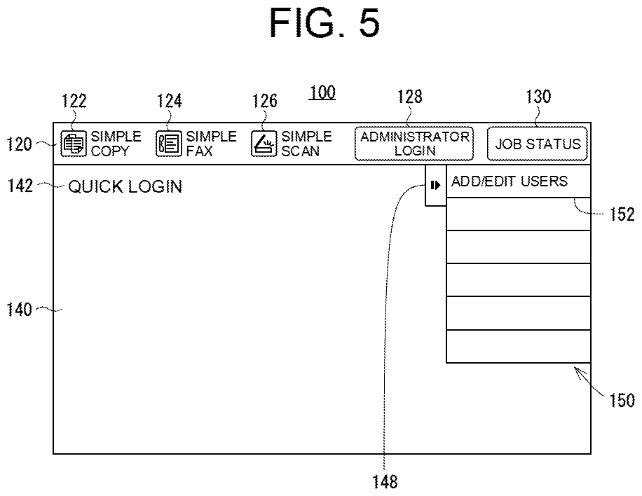

When the tab 148 is operated on the quick login screen 100 shown in FIG. 4, the quick login screen 100 changes to the state shown in FIG. 5. That is to say, an action panel 150 is displayed so as to cover a portion of the right side of the primary display area 140. The action panel 150 includes an add/edit user button 152 for displaying an add/edit user screen 200 described below.

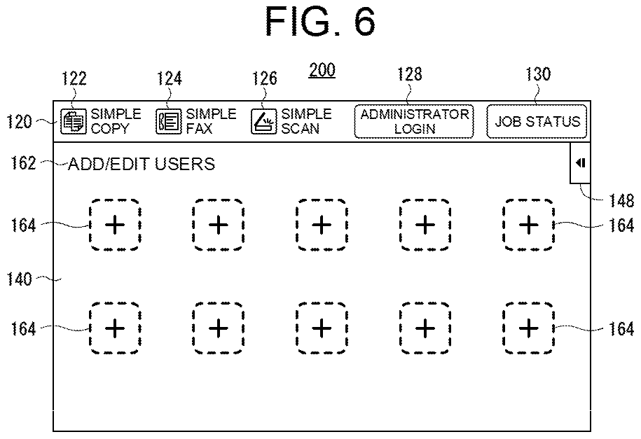

When the add/edit user button 152 inside the action panel 150 is pressed on the quick login screen 100 shown in FIG. 5, the add/edit user screen 200 shown in FIG. 6 is displayed on the display 22a instead of the quick login screen 100. The add/edit user screen 200 is a screen in which the display content of the primary display area 140 is different from that of the quick login screen 100. Otherwise, the add/edit user screen 200 and the quick login screen 100 share common elements, and these are assigned the same reference symbols and the description thereof will be omitted.

An appropriate character string 162 representing the title of the add/edit user screen 200 is arranged at an upper portion of the primary display area 140 on the add/edit user screen 200 shown in FIG. 6. Further, a plurality of, for example, ten unregistered icons 164 having an appropriate graphic are arranged in rows of five in the horizontal direction and columns of two in the vertical direction below the character string 162.

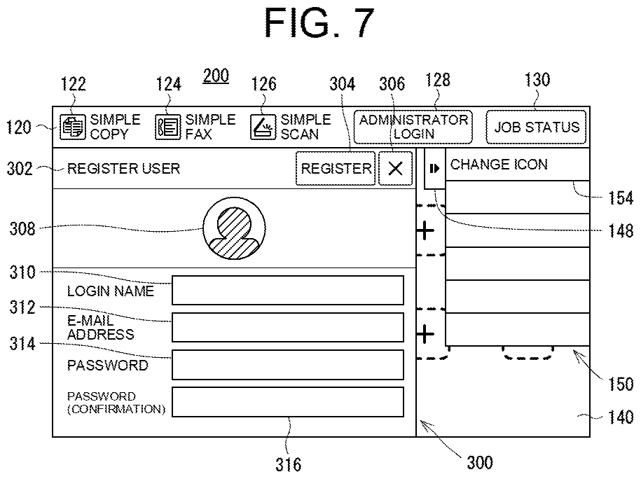

When an arbitrary unregistered icon 164 is operated on the add/edit user screen 200 shown in FIG. 6, the add/edit user screen 200 changes to the state shown in FIG. 7. That is to say, a small screen referred to as a user registration screen for new registrations 300 is displayed so as to cover a portion of the left side of the primary display area 140 up to a substantially central portion.

Arranged side-by-side at an upper portion of the user registration screen for new registrations 300 are an appropriate character string 302 representing the title of the user registration screen 300, a registration button 304 for setting the registration content according to the user registration screen 300, and a close button 306 for closing the user registration screen 300. Further, below these is arranged an icon image 308 representing an original image of the icon 144 described above (FIG. 3). Further, arranged in a single column below the icon image 308 are a plurality of, for example, four fields 310, 312, 314 and 316. The top field 310 is a field for entering a login name for the user that is about to be registered. The second field 312 is a field for registering an e-mail address of the user. Further, the third field 314 is a field for entering an optional password for the user that is about to be registered. The bottom field 316 is a field for re-entering the password for confirmation.

In addition, the action panel 150 is displayed when the tab 148 described above is operated. However, the action panel 150 in FIG. 7 displays a change icon button 154 for changing the icon image 308, that is to say, for changing the icon 144.

An icon selection screen (not shown) is displayed when, for example, the change icon button 154 inside the action panel 150 is operated on the add/edit user screen 200, which includes the user registration screen for new registrations 300 and the action panel 150 shown in FIG. 7. The icon selection screen includes a plurality of icon samples. When an arbitrary icon sample is selected (operated), an icon image 308 corresponding to the selected icon sample is displayed. At the same time, the icon selection screen is closed. Then, an arbitrary (desired) login name is entered into the top field 310. Entry of an e-mail address into the second field 312 is not required, and is optional. Furthermore, entry of a password into the third field 314 and the bottom field 316 is also not required, and is optional. A software keyboard (not shown) is displayed at the time of entry into these fields 310, 312, 314 and 316.

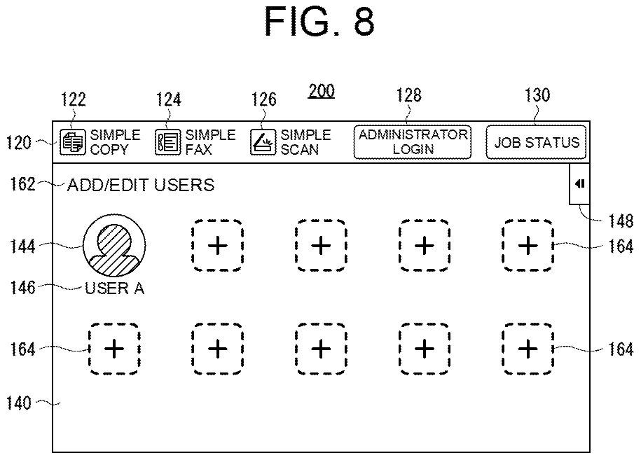

When the registration button 304 is operated after at least the login name has been entered into the top field 310, the registration content including the login name is set. At the same time, the user registration screen 300 is closed. Then, the add/edit user screen 200 changes to the state shown in FIG. 8. If the close button 306 on the user registration screen 300 is operated, the user registration screen 300 is closed as is, that is to say, the state before the user registration screen 300 was displayed is restored.

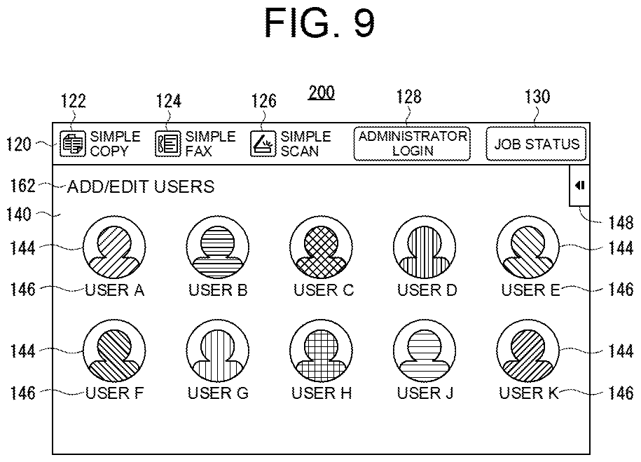

On the add/edit user screen 200 shown in FIG. 8, the icon 144 of the user and a character string 146 representing the login name of the user are displayed based on the content registered in the user registration screen 300 described above. Other users can be arbitrarily registered in the same manner. For example, by performing registrations for ten users, the add/edit user screen 200 becomes the state shown in FIG. 9.

Although not illustrated, when the tab 148 is operated on the add/edit user screen 200 shown in FIG. 9, the action panel 150 is displayed. The action panel 150 is provided with a return to login screen button for returning to the quick login screen 100. When the return to login screen button is operated, the quick login screen 100 described above and shown in FIG. 3 is displayed instead of the add/edit user screen 200 on the display 22a. Furthermore, the quick login screen 100 is displayed instead of the add/edit user screen 200 by operating a home button (not shown) constituting the operation unit 24.

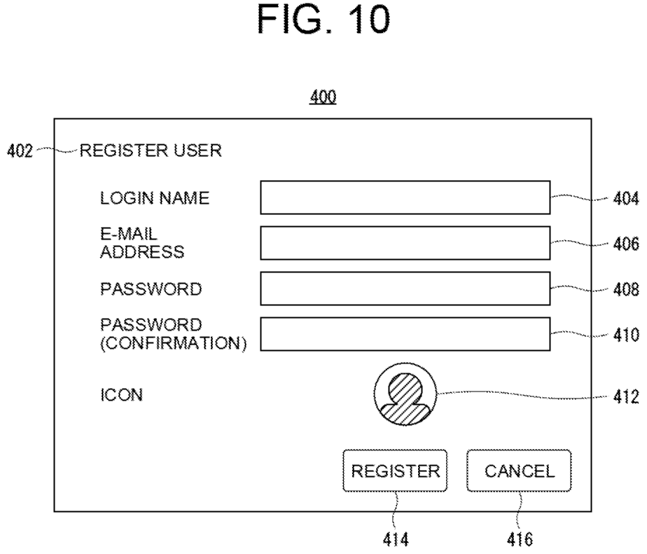

An administrator that has logged in as the administrator as described above may also arbitrarily register a user in the same manner. Furthermore, the administrator may log in to the multifunction peripheral 10 using one of the PCs 30 (see FIG. 2), and also perform user registration from the PC 30. In this case, for example, a user registration screen for new registrations 400 as shown in FIG. 10 is displayed on the display (not shown) of the PC 30.

An appropriate character string 402 representing the title of the user registration screen 400 is arranged at an upper portion of the user registration screen 400 shown in FIG. 10. Further, arranged in a single column below the character string 402 are a plurality of, for example, four fields 404, 406, 408 and 410. The top field 404 is a field for entering a login name for the user that is about to be registered. The second field 406 is a field for registering an e-mail address of the user. Further, the third field 408 is a field for entering an optional password for the user that is about to be registered. The bottom field 410 is a field for re-entering the password for confirmation. Also, below the fields 404, 406, 408 and 410 is arranged an icon image 412 representing an original image of the icon 144 described above (FIG. 3). In addition, arranged side-by-side below the icon image 412 are a registration button 414 for setting the registration content on the user registration screen 400, and a cancel button 416 for cancelling user registration by the user registration screen 400.

User registration can be performed on the user registration screen 400 shown in FIG. 10 in the same manner as the user registration screen 200 described above (FIG. 7). Although not illustrated, an icon selection screen equivalent to that described above is displayed by operating (for example, double-clicking) the icon image 412. Further, when the registration button 414 is operated (for example, by single-clicking) after at least the login name has been entered into the top field 404, the registration content including the login name is set. At the same time, the user registration screen 400 is closed. On the other hand, if the cancel button 416 is operated, the user registration screen 400 is closed as is, that is to say, the state before the user registration screen 400 was displayed is restored.

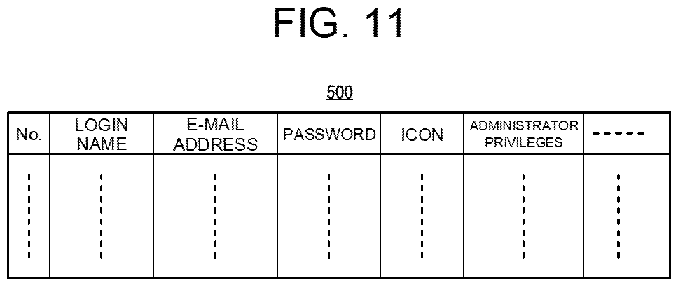

When user registration is performed in this manner by operation of the multifunction peripheral 10 body or a PC 30, user information according to the user registration is recorded in a user management table 500 as shown in FIG. 11. Specifically, a reference number (No.), a login name, an e-mail address, a password, an icon (or more precisely, an icon number), and the like are recorded as the user information. Furthermore, if the user registration is performed by an administrator logged in as the administrator, that is to say, as a result of administrator privileges, this information (a type of flag) is also recorded. As described above, entry (registration) of an e-mail address and a password is optional. Furthermore, the user management table 500 is, for example, stored in the primary storage unit 16b of the control unit 16.

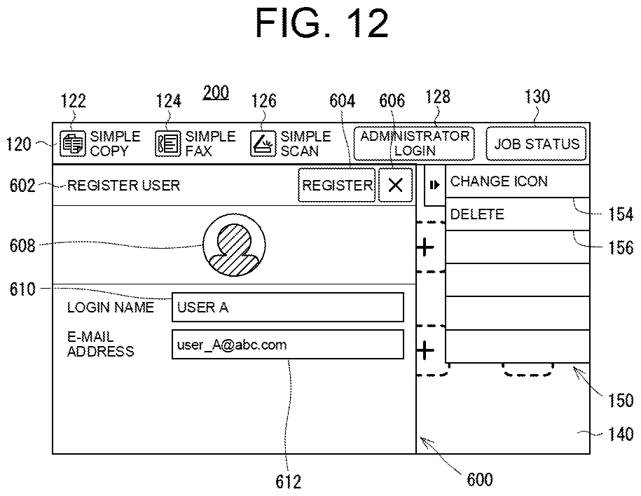

In the first embodiment, it is also possible to edit registered user information. In this case, for example, the icon 144 corresponding to the user information targeted for editing is operated on the add/edit user screen 200 shown in FIG. 9. Then, the add/edit user screen 200 changes to the state shown in FIG. 12. That is to say, a small screen referred to as a user registration screen for editing 600 is displayed so as to cover a portion of the left side of the primary display area 140 up to a substantially central portion. FIG. 12 shows a state where the icon 144 corresponding to “user A” has been operated on the add/edit user screen 200 shown in FIG. 9.

In the same manner as the user registration screen for new registrations 300 described above (FIG. 7), arranged at the upper portion of the user registration screen for editing 600 is an appropriate character string 602 representing the title of the user registration screen 600. At the same time, arranged side-by-side are a registration button 604 for setting the registration (edited) content according to the user registration screen for editing 600, and a close button 606 for closing the user registration screen 600. Further, below these is arranged an icon image 608. In addition, arranged in a single column below the icon image 608 are two fields 610 and 612. The upper field 610 is a field for editing a login name. The lower field 612 is a field for editing an e-mail address.

In addition, the action panel 150 is displayed when the tab 148 described above is operated. In addition to the change icon button 154, the action panel 150 in FIG. 12 displays a delete button 156 for deleting the user information targeted for editing, that is to say, for deleting a registered user.

The icon selection screen described above is displayed when, for example, the change icon button 154 inside the action panel 150 is operated on the add/edit user screen 200, which includes the user registration screen for editing 600 and the action panel 150 shown in FIG. 12. An icon image 608 can be edited (changed) on the icon selection screen. Then, the login name can be optionally changed by means of the upper field 610. Further, the mail address can be optionally changed by means of the lower field 612. A software keyboard (not shown) is displayed at the time the information entered into these fields 610 and 612 is edited. The password cannot be edited. Furthermore, user information having a set password can be edited without entering the password.

When the registration button 604 is operated after the editing has been performed, the edited content is set. That is to say, the content of the user management table 500 is updated. At the same time, the user registration screen 600 is closed. Then, the add/edit user screen 200 changes to a state which reflects the edited content. If the close button 606 on the user registration screen 600 is operated, the user registration screen 600 is closed as is, that is to say, the state before the user registration screen 600 was displayed is restored. Further, if the delete button 156 inside the action panel 150 is operated, the user information targeted for editing is deleted. Then, the add/edit user screen 200 becomes a state which is based on the content of the user management table 500 after the user information has been deleted.

An administrator that has logged in as the administrator as described above may also edit arbitrary user information in the same manner. Furthermore, the administrator may log in to the multifunction peripheral 10 using one of the PCs 30 (see FIG. 2), and also edit user information from the PC 30. A detailed explanation of the editing procedure of the user information using the PC 30 is omitted.

In the first embodiment, the registered user information can be edited in this manner. However, if this is allowed without restriction, inconveniences will occur particularly in relation to unintended editing of the user information by a third party. In the first embodiment, the following measures are provided in order to prevent unintended editing of user information and to realize appropriate management of the user information, while preserving user convenience by means of simple authentication.

That is to say, user information registered by a general user may be edited by any user, including the general user. In contrast, user information registered by an administrator may be edited on the condition that a user who edits the user information is the administrator, and may not be edited by other users, that is to say, by a general user. Whether the user information was registered by a general user or an administrator is determined based on the existence of administrator privileges in the user management table 500 described above (FIG. 11).

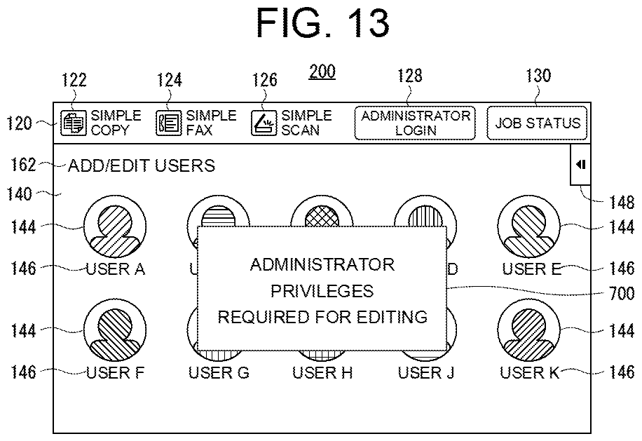

For example, suppose that on the add/edit user screen 200 shown in FIG. 9 an icon 144 corresponding to user information registered by an administrator is operated by a general user, that is to say, without the administrator login button 128 being pressed. Then, a warning message (message box) 700 as shown in FIG. 13 is displayed on the add/edit user screen 200. The warning message 700 is displayed over an appropriate period of several seconds up to approximately twenty seconds. Then, the add/edit user screen 200 returns to the state shown in FIG. 9. In this manner, unintended editing of user information is prevented, and appropriate management of the user information is realized. An appropriate audio announcement may be output from a speaker serving as an audio outputter instead of, or in addition to, displaying the warning message 700.

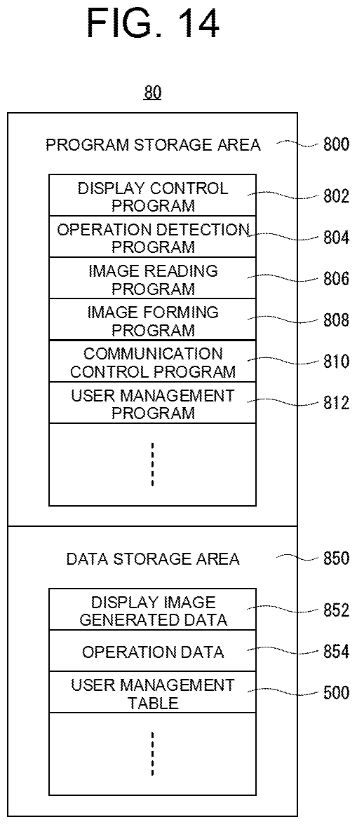

Here, a memory map 80 conceptually representing the configuration inside a RAM of the primary storage unit 16b is shown in FIG. 14.

As illustrated in the memory map 80, the RAM includes a program storage area 800 and a data storage area 850. Among these, the program storage area 800 stores the control program described above. Specifically, the control program includes a display control program 802, an operation detection program 804, an image reading program 806, an image forming program 808, a communication control program 810, a user management program 812, and the like.

The display control program 802 is a program for generating the display screen data necessary for causing the display 22a to display various screens, such as the quick login screen 100 and the add/edit user screen 200. The operation detection program 804 is a program for detecting an operation state with respect to the touch panel 24a. The image reading program 806 is a program for controlling the image reading unit 12. The image forming program 808 is a program for controlling the image forming unit 14. The communication control program 810 is a program for controlling the communication unit 20. Further, the user management program 812 is a program for causing the CPU 16a to execute a user management task as described below.

On the other hand, various data is stored in the data storage area 850. The various data includes display image generated data 852, operation data 854, and the user management table 500 described above.

The display image generated data 852 is data such as polygon data or texture data used for generating display screen data based on the display control program 802 described above. The operation data 854 is data that represents the operation state with respect to the touch panel 24a, and specifically is time series data that represents user touch locations (coordinates) with respect to the touch panel 24a. Then, the user information relating to each user is recorded in the user management table 500 in the manner described above.

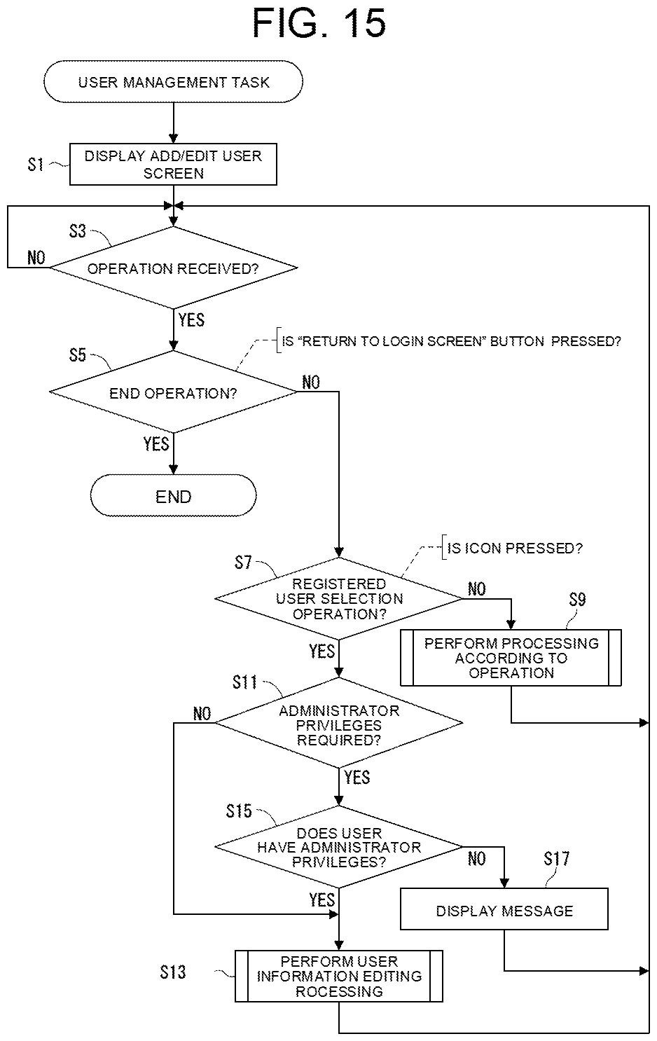

As described above, according to the first embodiment, although registered user information can be edited, certain restrictions are provided at the time of editing. In order to realize this, the CPU 16a executes a user management task according to the user management program 812 described above (FIG. 14). The flow of the user management task is shown in FIG. 15. The CPU 16a executes the user management task as a result of the add/edit user button 152 inside the action panel 150 on the quick login screen 100 described above (for example, FIG. 5) being pressed.

According to the user management task, in step Si the CPU 16a firstly displays the add/edit user screen 200 on the display 22a. The display content of the add/edit user screen 200 is based on the content registered in the user management table 500. Then, the CPU 16a advances the processing to step S3.

In step S3, the CPU 16a waits for an operation to be performed with respect to the operation unit 24, which includes the touch panel 24a (S3: NO). Then, when an operation is accepted by the operation unit 24 (S3: YES), the CPU 16a advances the processing to step S5.

In step S5, the CPU 16a determines whether or not the operation accepted in step S3 is an end operation, that is to say, whether or not the operation represents operation of the return to login screen button described above, which is provided inside the action panel 150 on the add/edit user screen 200. Here, for example, if the operation accepted in step S3 is the end operation, that is to say, the operation represents an operation of the return to login screen button (S5: YES), the CPU 16a ends the user management task. Then, the CPU 16a returns to the quick login mode by means of a separate task (quick login task) (not shown), and displays the quick login screen 100 described above (for example, FIG. 5) on the display 22a. On the other hand, if the operation accepted in step S3 is not the end operation (S5: NO), the CPU 16a advances the processing from step S5 to step S7.

In step S7, the CPU 16a determines whether or not the operation accepted in step S3 is an operation selecting one of the icons 144. Here, for example, if the operation accepted in step S3 is not an operation selecting one of the icons 144 (S7: NO), the CPU 16a advances the processing to step S9 described below. On the other hand, if the operation accepted in step S3 is an operation selecting one of the icons 144 (S7: YES), the CPU 16a advances the processing to step S11 described below.

In step S9, the CPU 16a executes processing according to the operation accepted in step S3. The processing in step S9 includes processing for newly registering user information and processing for editing user information. Then, the CPU 16a returns the processing to step S3.

After advancing the processing from step S7 described above to step S11, the CPU 16a determines in step S11 whether or not the target user information is information that was registered by an administrator, that is to say, whether or not administrator privileges are required for editing the user information. Here, for example, if the target user information is not information that was registered by an administrator, that is to say, administrator privileges are not required for editing the user information (S11: NO), the CPU 16a advances the processing to step S13. On the other hand, if the target user information is information that was registered by an administrator, that is to say, administrator privileges are required for editing the user information (S11: YES), the CPU 16a advances the processing to step S15.

In step S13, the CPU 16a performs user information editing processing. Specifically, the CPU 16a displays the user registration screen for editing 600 (see FIG. 12). Then, the CPU 16a edits the user information inside the user management table 500, that is to say, updates the user management table 500 according to a user operation with respect to the user registration screen for editing 600. After executing user information editing processing in step S13, the CPU 16a returns the processing to step S3. At that time, after display of the user registration screen for editing 600 has been completed, the CPU 16a re-displays the add/edit user screen 200 based on the updated user management table 500.

After advancing the processing from step S11 described above to step S15, the CPU 16a determines in step S15 whether or not the current user is an administrator, that is to say, whether or not the user holds administrator privileges. Here, for example, if the current user is an administrator, that is to say, the user holds administrator privileges (S15: YES), the CPU 16a advances the processing to step S13. On the other hand, if the current user is not an administrator, that is to say, the user is a general user who does not hold administrator privileges (S15: NO), the CPU 16a advances the processing to step S17. A separate task (administrator login task) (not shown) is used to determine whether or not the current user is an administrator.

In step S17, the CPU 16a displays the message 700 described above (FIG. 13). Then, the CPU 16a returns the processing to step S3.

In the manner above, according to the first embodiment, although registered user information can be edited, certain restrictions are provided at the time of editing. Consequently, it is possible to realize appropriate management of user information while preserving user convenience by means of simple authentication.

### Second Embodiment

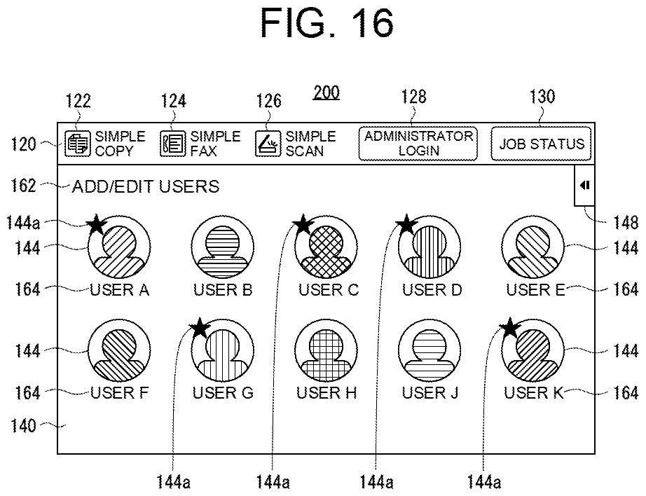

Next, a second embodiment of the present embodiment will be described with reference to FIG. 16.

In the second embodiment, a measure is provided with respect to the configuration of the add/edit user screen 200. That is to say, as shown in FIG. 16, a star symbol 144a is assigned to several of the icons 144 on the add/edit user screen 200 in the second embodiment. The star symbol 144a indicates that the user information corresponding to the assigned icon 144 is information that was registered by an administrator. That is to say, the information cannot be edited unless the user is an administrator. In other words, an icon 144 corresponding to user information that was registered by an administrator and an icon 144 corresponding to user information that was registered by a general user, who is not an administrator, are displayed differently.

According to the second embodiment provided with such a measure, it can be intuitively grasped whether each user information entry represents information that was registered by an administrator, or information that was registered by a general user. This is useful for the efficient management of user information.

This distinction is not limited to the assignment of a star symbol 144a. The distinction may be made by assigning a specific color or pattern to each of the icons 144. Furthermore, a distinction between user information having a set password and user information not having a set password may be made in the same manner. Further, a similar distinction may be made on the quick login screen 100.

### Third Embodiment

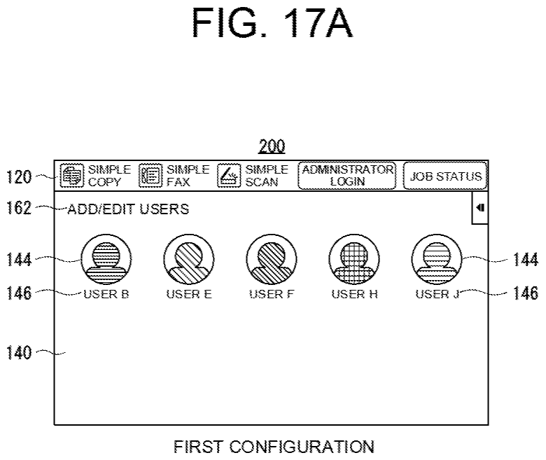

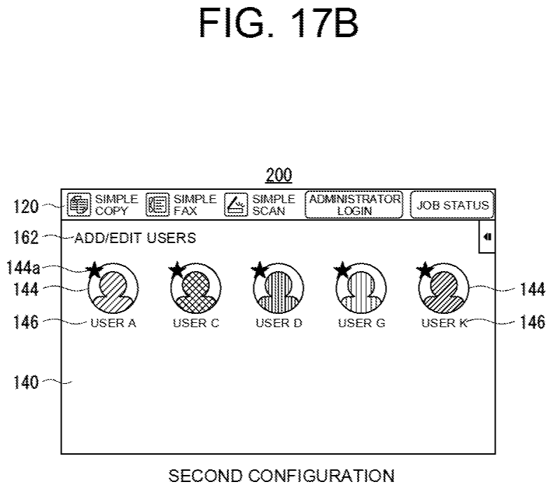

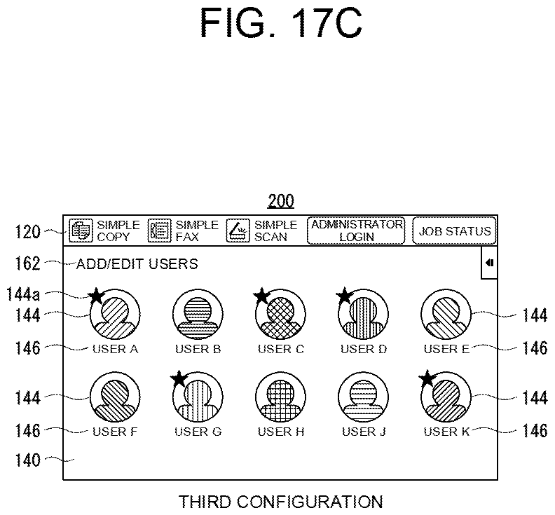

Next, a third embodiment of the present embodiment will be described with reference to FIGS. 17A to 17C.

Similarly in the third embodiment, a measure is provided with respect to the configuration of the add/edit user screen 200. Specifically, in the third embodiment, the configuration of the add/edit user screen 200 may be arbitrarily selected from a first configuration shown in FIG. 17A, a second configuration shown in FIG. 17B, and a third configuration shown in FIG. 17C. The first configuration shown in FIG. 17A is a configuration in which, of the user information registered in the user management table 500, only those icons 144 that correspond to the user information that was recorded by a general user are displayed. Further, the second configuration shown in FIG. 17B is a configuration in which, of the user information registered in the user management table 500, only those icons 144 that correspond to the user information that was recorded by an administrator are displayed. In addition, the third configuration shown in FIG. 17C is a configuration in which the icons 144 corresponding to all of the user information recorded in the user management table 500 are displayed. Which of the three configurations is displayed may be arbitrarily set by a setting screen (not shown) that can be operated only by an administrator that has logged in as the administrator.

According to the third embodiment provided with such a measure, an appropriate add/edit user screen 200 can be presented to a user according the usage status of the multifunction peripheral 10, which includes information relating to the type of users that are using the multifunction peripheral 10. This particularly contributes to an improvement in the usability of the multifunction peripheral 10.

In a similar manner to the second embodiment described above, distinctions are made in the third embodiment by assigning a star symbol 144a. However, such distinctions do not have to be made. That is to say, a star symbol 144a does not have to be displayed.

Furthermore, the three configurations shown in FIGS. 17A to 17C may be mutually switchable. Which of the configurations is activated (that is to say, which of the three types of add/edit user screens 200 shown in FIGS. 17A to 17C is displayed) may be decided by an administrator or by a general user who is not an administrator.

### Fourth Embodiment

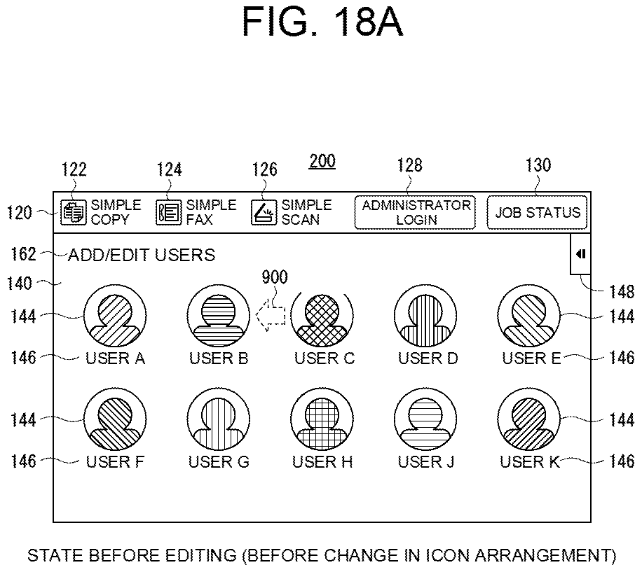

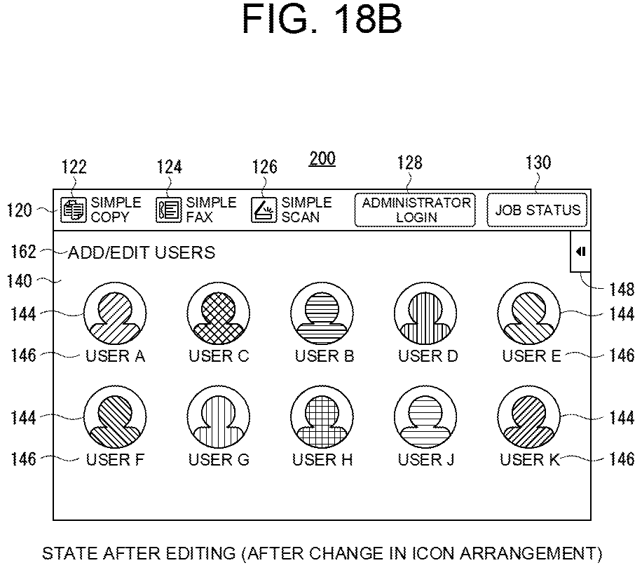

Next, a fourth embodiment of the present embodiment will be described with reference to FIGS. 18A and 18B.

In the fourth embodiment, an arrangement (layout) of the icons 144 in the add/edit user screen 200 can be arbitrarily changed. For example, as shown in FIG. 18A, suppose that the icon 144 corresponding to “user C” is made to horizontally slide (is swiped) to the left, as indicated by the dotted arrow 900, while the icon 144 is pressed. Further, suppose that the pressed state of the icon 144 corresponding to “user C” is released (the finger separates from the icon 144 corresponding to “user C”) after the icon 144 corresponding to “user C” has been made to slide to the position of the icon 144 corresponding to “user B”. Then, as shown in FIG. 18B, the position of the icon 144 corresponding to “user C” and the position of the icon 144 corresponding to “user B” are mutually switched. That is to say, the positions of the icons 144 can be swapped. The changed positions of the icons 144 are also reflected on the quick login screen 100.

According to the fourth embodiment, an appropriate quick login screen 100 can be presented to a user according the usage status of the multifunction peripheral 10, which includes information relating to the number of registered user information entries. This also greatly contributes to an improvement in the usability of the multifunction peripheral 10.

In the fourth embodiment, a change in the positions of the icons 144 can only be executed by an administrator that has logged in as the administrator. However, this may also be executed by a general user who is not an administrator. Furthermore, in a similar manner to the second embodiment described above, distinctions are made in the fourth embodiment by assigning a star symbol 144a and the like.

### OTHER APPLICATION EXAMPLES

The embodiments above are specific examples of the present invention, and in no way limit the technical scope of the present invention. The present invention can be applied in situations other than those described in the embodiments.

For example, although the password was described as being uneditable, the password may be editable.

Furthermore, an administrator is capable of registering and editing user information using a PC 30. However, a general user may also be capable of registering and editing user information using a PC 30. However, in this case, it is important that certain restrictions be placed on editing by general users.

Further, in the embodiments, examples were described in which the present embodiment is applied to a multifunction peripheral 10. However, it is not limited to this. The present invention may of course be applied to an information processing device other than a multifunction peripheral 10.

The operation of an arbitrary icon 144 with an object of editing user information on the add/edit user screen 200 as described above corresponds to an edit instruction according to the present invention, and in other words, is an example of the edit instruction. Further, the touch panel 24a that accepts the operation of the icon 144 cooperates with the CPU 16a to constitute an example of an edit instruction acceptor according to the present invention. In addition, when user information is edited using a PC 30, an instruction for performing the editing is received by the CPU 16a. Similarly in this case, the CPU 16a represents an example of an edit instruction acceptor according to the present invention.

In addition, the administrator privileges described above are an example of a specified privilege according to the present invention. An administrator having administrator privileges is an example of a privileged user according to the present invention. Further, the user information registered by an administrator is an example of specific registered information according to the present invention. On the other hand, a general user who does not have administrator privileges is an example of a non-privileged user according to the present invention. Also, the user information registered by a general user is an example of non-specific registered information according to the present invention.

Furthermore, the CPU 16a determines whether or not editing of user information is allowed. Such a CPU 16a, and more precisely a CPU 16a that specifically executes step S15 in the user management task described above (FIG. 15) is an example of a permitter according to the present invention. Further, the CPU 16a, which displays the warning message 700 by executing step S17, cooperates with the display 22a to constitute a warning outputter according to the present invention.

Further, the first configuration in the third embodiment described with reference to FIGS. 17A to 17C is an example of the second state according to the present invention. Also, the second configuration in the third embodiment is an example of the first state according to the present invention. Moreover, the third configuration in the third embodiment is an example of the third state according to the present invention.

Further, the change in the position of the icons 144 in the fourth embodiment described with reference to FIGS. 18A and 18B is performed as a result of the CPU 16a receiving operations with respect to the icons 144. However, the CPU 16a is merely an example of a changer according to the present invention. At the same time, the CPU 16a cooperates with the touch panel 24a to constitute an example of the change instruction acceptor. Moreover, an operation with respect to an icon 144 with an object of changing the position of the icon 144 is an example of the change instruction according to the present invention.

What is claimed is:

1. An information processing device comprising a display unit that displays an icon corresponding to each user based on pre-registered user information, the information processing device further comprising:
an edit instruction acceptor that accepts an edit instruction to edit the user information corresponding to the icon corresponding to an arbitrary user; and
a permitter that allows editing of the user information according to the edit instruction if the user information relating to the edit instruction is non-specific registered information that has been registered by a non-privileged user who does not have a specific privilege, and allows editing of the user information according to the edit instruction on the condition that a user who has transmitted the edit instruction is a privileged user having the specific privilege if the user information relating to the edit instruction is specific registered information that has been registered by the privileged user.

2. The information processing device according to claim 1, further comprising a warning outputter that outputs a predetermined warning if the user information relating to the edit instruction is the specific registered information, and a user who has transmitted the edit instruction is the non-privileged user.

3. The information processing device according to claim 1, further comprising a communicator that communicates with an external device, wherein
the edit instruction acceptor is capable of accepting the edit instruction from the external device via the communicator.

4. The information processing device according to claim 1, wherein
the display unit displays one or more icons based on the specific registered information and one or more icons based on the non-specific registered information differently from each other.

5. The information processing device according to claim 1, wherein
the display unit is switchable to any of a first state in which only one or more icons based on the specific registered information are displayed, a second state in which only one or more icons based on the non-specific registered information are displayed, and a third state in which both of the icons based on the specific registered information and the icons based on the non-specific registered information are displayed.

6. The information processing device according to claim 1, further comprising:
a change instruction acceptor that accepts, from the privileged user, a change instruction to change arrangement of the icon; and
a changer that changes the arrangement of the icon according to the change instruction.

7. The information processing device according to claim 1, wherein
the information processing device is a multifunction peripheral.

8. A non-transitory computer readable recording medium storing a user management program for an information processing device provided with a display unit that displays an icon corresponding to each user based on pre-registered user information, the program causing a computer of the information processing device to execute:
an edit instruction accepting procedure that accepts an edit instruction to edit the user information corresponding to the icon corresponding to an arbitrary user; and
a permission procedure that allows editing of the user information according to the edit instruction if the user information relating to the edit instruction is non-specific registered information that has been registered by a non-privileged user who does not have a specific privilege, and allows editing of the user information according to the edit instruction on the condition that a user who has transmitted the edit instruction is a privileged user having the specific privilege if the user information relating to the edit instruction is specific registered information that has been registered by the privileged user.

9. A user management method for an information processing device provided with a display unit that displays an icon corresponding to each user based on pre-registered user information, the user management method comprising:
accepting an edit instruction to edit the user information corresponding to the icon corresponding to an arbitrary user; and
allowing editing of the user information according to the edit instruction if the user information relating to the edit instruction is non-specific registered information that has been registered by a non-privileged user who does not have a specific privilege, and allowing editing of the user information according to the edit instruction on the condition that a user who has transmitted the edit instruction is a privileged user having the specific privilege if the user information relating to the edit instruction is specific registered information that has been registered by the privileged user.
